(19) United States
(12) Patent Application Publication
(10) Pub. No.: US 2017/0336057 A1
(43) Pub. Date: Nov. 23, 2017

(54) DEVICE AND METHOD FOR SURFACE MOUNTING OF ELECTRICAL DEVICES

(71) Applicant: PHILIPS LIGHTING HOLDING B.V., EINDHOVEN (NL)

(72) Inventor: BRIAN DAVID CLARKE, BELLINGHAM, MA (US)

(21) Appl. No.: 15/523,856

(22) PCT Filed: Nov. 3, 2015
(86) PCT No.: PCT/IB2015/058491

§ 371 Date: May 2, 2017

Related U.S. Application Data
(60) Provisional application No. 62/076,600, filed on Nov. 7, 2014.

(51) Int. Cl. F21V 21/04; F21V 23/06; F21Y 2115/10

(52) U.S. Cl. CPC F21V 21/041; F21V 23/06; F21Y 2115/10

(57) ABSTRACT

Inventive methods and apparatus for providing a surface mounted electrical device whereby at least one stem is employed which provides both an electrical connection to a power source as well as the means for mounting. One example of such an electrical device is a ceiling surface-mount luminaire that gives the appearance of a recessed luminaire without requiring the material and cost of a recessed housing. The disclosed invention reduces product cost and increases speed and ease of installation.

The present invention is directed to an electrical device for mounting on a surface, in a manner that reduces product cost and increases speed and ease of the installation process. By way of example, the invention provides a surface-mount luminaire that gives the appearance of a recessed luminaire without requiring the material and cost of a recessed housing.

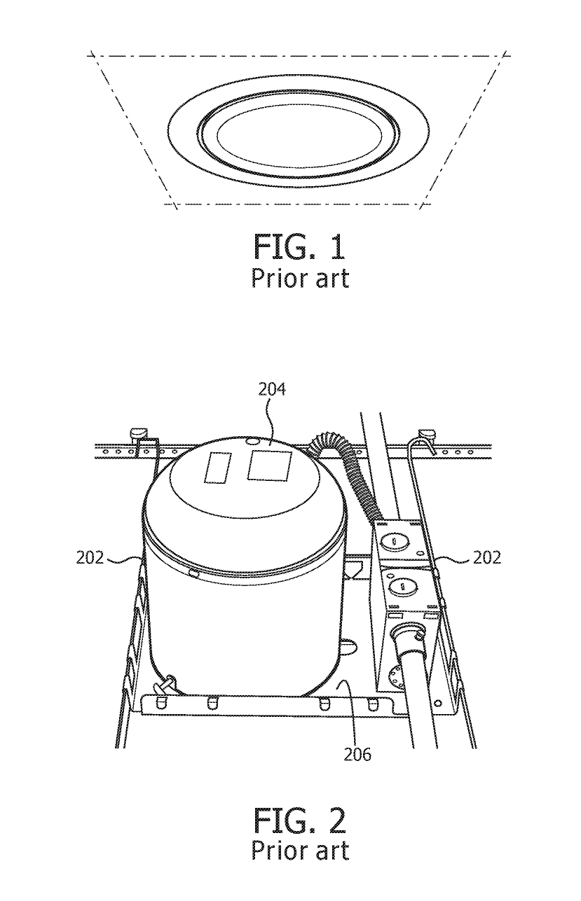

Recessed luminaires came into application in the 1950s when a metal box or cylinder (i.e., a “recessed housing”) with a lamp in it was placed above a hole in the ceiling. As depicted in FIG. 1, this type of luminaire provided a unique unobtrusive look since essentially all portions of the luminaire were located above the ceiling. It also had the ability to provide a sharp cut off of light as the light passes through the aperture created by the hole in the ceiling. As different light sources have been developed, they have replaced the original incandescent lamp in the recessed housing. That is, recessed luminaires are currently available with incandescent, HID, fluorescent and even LED light sources.

As depicted in FIG. 2, the construction of traditional recessed luminaires involves a substantial amount of material (metal) contained in the recessed housing itself (204), plaster frame (206) and the mounting brackets (202). The height of the recessed housing can limit the locations where the luminaire can be installed since there must be room above the ceiling to fit the tall recessed housing. The opening (aperture) in the ceiling is typically large (e.g., 4″-8″) and as such requires additional care and often a special tool to cut. Since the size of the opening is essentially the finished size, there is very little latitude for positioning error. There is only one opportunity to position the luminaire opening correctly if installing after the ceiling is in place. In addition, the requirements of a large opening and the structure directly above that opening may preclude installation of the luminaire in the desired position of the ceiling. That is, by way of examples, the space above the mounting location may contain ceiling joists, duct work, or even pipes that are too close to accommodate the recessed housing in the desired location of the luminaire. In addition, heat generated within the recessed housing unit may also preclude installation where insufficient space above the unit is available. Many municipalities have building codes that require a minimum heat dissipation space, which includes how close ceiling insulation can be positioned.

The present disclosure is directed to inventive methods and apparatus that eliminates the recessed housing altogether and at least one mounting bracket. This saves material, weight and cost. Accordingly to one aspect of the invention, the light source is LED based and is located solely on the room side of the ceiling. This arrangement means that the hole in the ceiling need not be much larger than that required for an electrical connection and is therefore small in relation to the light source. This allows for easy repositioning of the luminaire should the hole be located incorrectly or the user later decide to relocate the luminaire.

Since the hole in the ceiling is small, conventional drill bits can be used. Because there is no aperture for the light to pass through, new non-traditional creative light shapes are possible, as described in various embodiments discussed below. The luminaire design of the present invention reduces the materials and hence the cost of the luminaire. The present invention allows installation in a greater number of applications, and the ease of installation is increased by forgoing the requirement to cut a large opening in the ceiling. The small mounting hole also allows easy relocation of the luminaire should it be positioned incorrectly or relocation is desired. In particular, the luminaire itself can simply hide the incorrect hole location when repositioning occurs within a distance that can be covered by the luminaire ‘trim.’ Further, when the repositioning occurs at a greater distance, the smaller hole involved is readily repaired.

Further, the present invention permits greater flexibility in positioning the lighting apparatus should space above the ceiling be limited or restricted by the presence of various objects above the ceiling. Still further, the present invention, by not creating a relatively large opening in the ceiling (and a corresponding gap in the insulation above the opening), provides better insulation of the room below for heating/air-conditioning functions.

For a better understanding of exemplary embodiments and to show how the same may be carried into effect, reference is made to the accompanying drawings. It is stressed that the particulars shown are by way of example only and for purposes of illustrative discussion of the preferred embodiments of the present disclosure, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 illustrates a room view of a traditional recessed lighting trim;

FIG. 2 illustrates an attic view of an exemplary prior art recessed luminaire and its mounting structure;

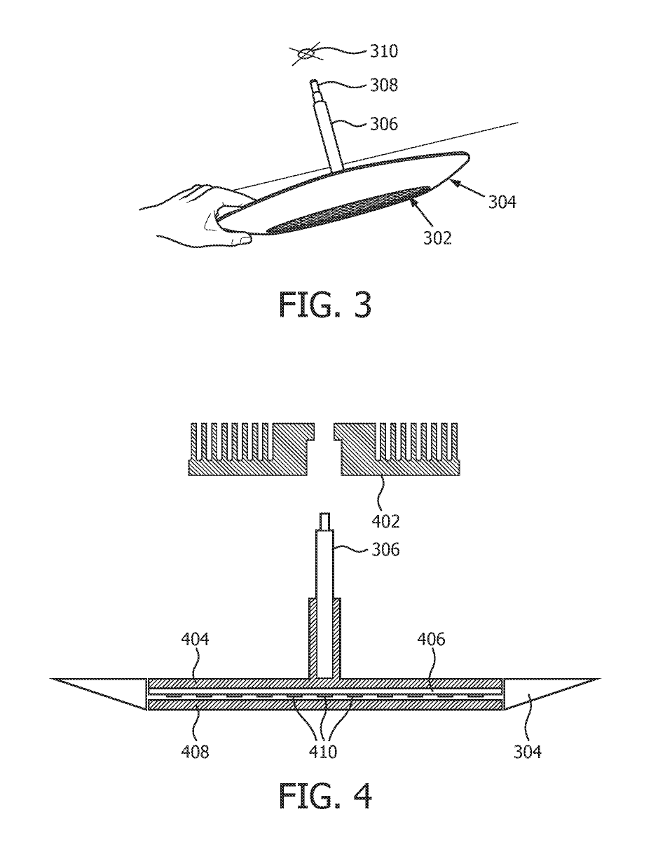

FIG. 3 illustrates a light fixture of the present invention;

FIG. 4 is a cross-sectional view of the light fixture of FIG. 3;

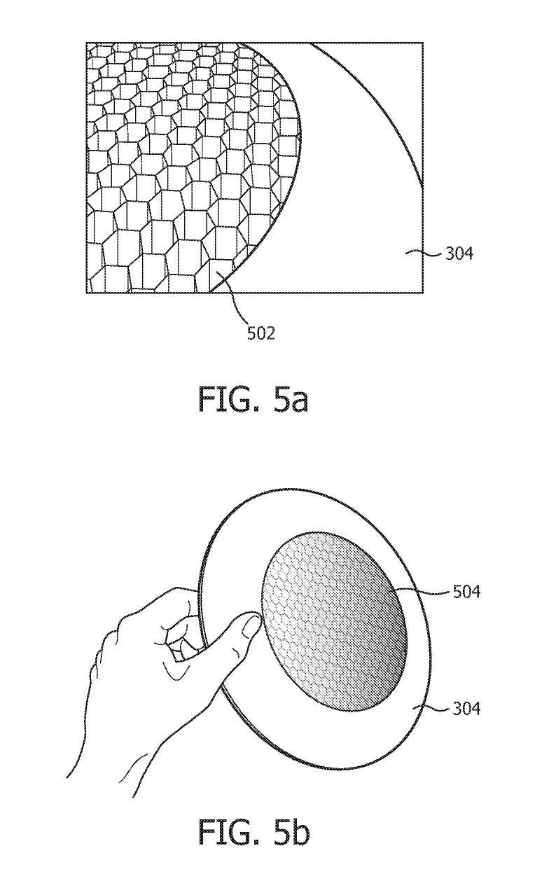

FIGS. 5a and 5b illustrate exemplary optical control elements of the present invention;

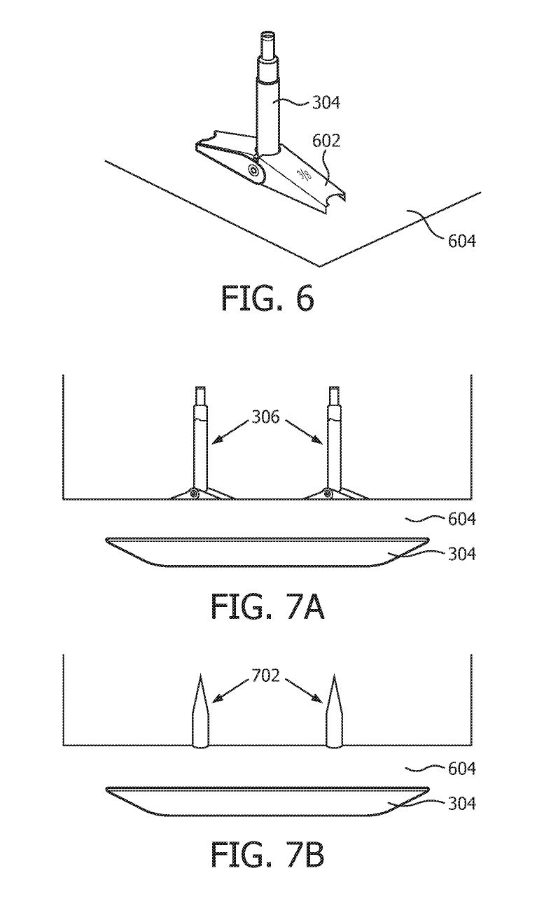

FIG. 6 illustrates an embodiment of the invention for securing the light fixture to a ceiling panel;

FIGS. 7A and 7B illustrate additional embodiments of the invention in which two stems are employed;

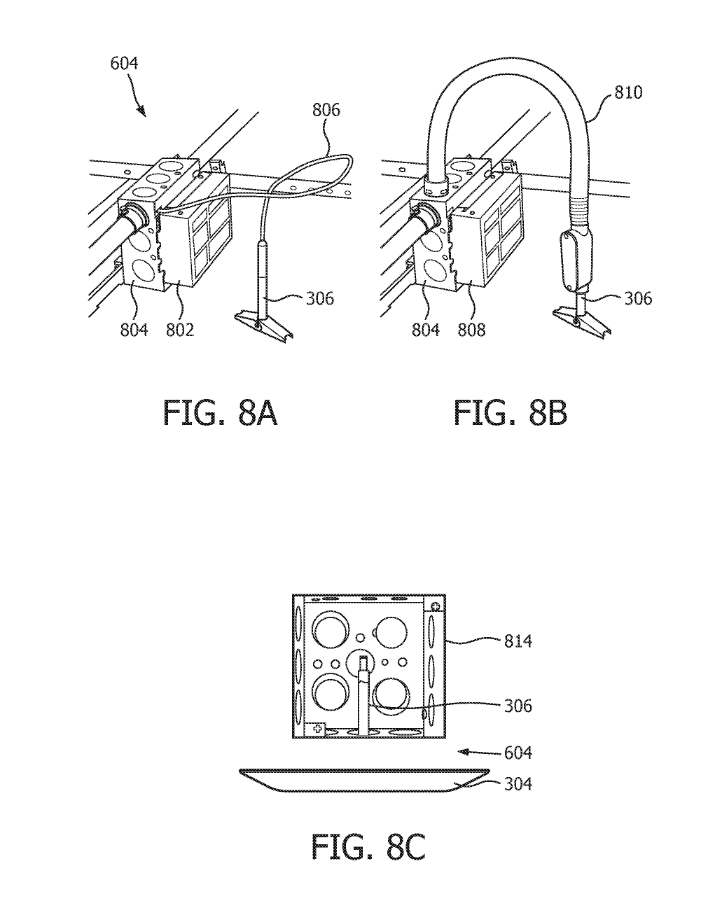

FIGS. 8A-8C illustrate an attic view of exemplary light fixture installations according to the invention; and,

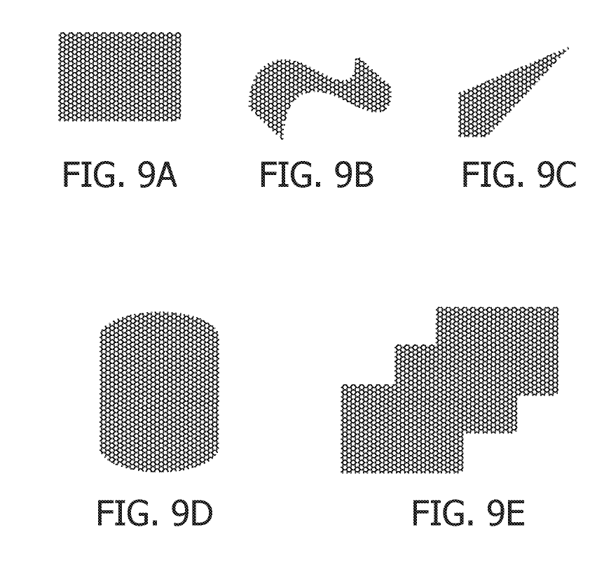

FIGS. 9A-9E illustrate examples of various light shapes that are enabled by the present invention.

It is to be understood that the figures and descriptions of the present invention described herein have been simplified to illustrate the elements that are relevant for a clear understanding of the present invention, while eliminating, for purposes of clarity many other elements. However, because these omitted elements are well-known in the art, and because they do not facilitate a better understanding of the present invention, a discussion of such element is not provided herein. The disclosure herein is directed to also variations and modifications known to those skilled in the art.

FIG. 3 illustrates an exemplary light fixture of the present invention. While this fixture resembles the appearance of the trim piece of a traditional recessed lighting fixture as depicted in FIG. 1, it should be noted that the LED light source(s) are located within the device 302 (as illustrated in greater detail in FIG. 4 described below). The integral decorative trim ring 304 in this embodiment of the invention is presented to yield the appearance of a conventional recessed light. It should be noted that the invention is not limited in this regard as alternative embodiments of the invention are contemplated in which the trim piece is of different shapes and/or sizes as well as absent altogether.

Further embodiments of the invention contemplate that the trim ring 304 can be separated from the rest of the luminaire to permit replacement in the event of damage or to change the appearance of the luminaire. Further, temporary removal of the trim ring 304 is advantageous in the installation of some embodiments of the invention (e.g., in the embodiment depicted in FIG. 7B below in which some force may be required to drive the spikes when installing the device).

In the embodiment depicted in FIG. 3 the luminaire has LEDs located on a printed circuit board that is approximately the same size as a traditional trim ring fixture. The LEDs are connected to an LED Driver (802), which is located in the rear, concealed space (e.g. attic space, wall space) through a hollow stem (306) that carries the electrical conductors (308). This stem is mechanically connected to the LED board and in one embodiment is provided with a low voltage coaxial power connector. The stem is easily installed thorough a small diameter hole (310) drilled through the ceiling. Should the hole be incorrectly positioned a new hole may be drilled within the diameter of the trim ring (304), allowing easy repositioning. Further, in situations where the incorrect hole is outside the diameter of the trim ring (304) (e.g., in situations in which the light is to be moved to a different position in the room ceiling), the small hole can be readily repaired.

As depicted in FIG. 4, the circuit board 406 comprising the LEDs 410 could also be backed by a heat sinking metal piece 404 that could be thermally connected to the stem 306 which could transmit heat to the space above the ceiling. In further embodiments the stem would connect to a complimentary, additional heat sink 402 located in this concealed space in situations in which the heat generated by the light source (items 410) warrants it. Although not illustrated, the invention contemplates that the LED driver could reside in the trim ring 304 or be positioned on the circuit board 406.

Also illustrated in FIG. 4 is an optical control element 408 that can be used as a simple protective lens or as a diffuser, baffle, louver, honeycomb, etc. By way of examples, FIG. 5a depicts a honeycomb grid assembly that provides a strong cutoff of the light emitted. FIG. 5b illustrates a diffuser example of the optical control element 408. In additional embodiments tubes can also be supplied as well as specialized optical treatments to provide directed light and cutoff.

FIG. 6 depicts an attic or back side view of an embodiment of the invention wherein the stem 306 is fastened in place above a ceiling 604 by a spring clip 602 that slides over the stem and provides tension on it. In additional embodiments (not illustrated) the stem can be secured by a simple spring steel clamp or by using a toothed or untoothed ratchet mechanism. In embodiments in which at least part of the stem 306 is threaded, a simple locking nut can be used to tighten the stem against the ceiling 604.

In further alternative embodiments, the illustrated tension spring clip 602 can be replaced with a toggle bolt mechanism and the stem 306 is provided with threads to engage the toggle bolt wing as is well known in the art (i.e., the toggle bolt wing acts as spring clip 602). Further embodiments contemplate use of a molly bolt mechanism and a threaded stem to secure the light to the ceiling. That is, a hole is first drilled, then molly bolt is inserted and tightened against the mounting surface in the conventional manner. The “tightening screw” is then removed and replace with the threaded stem clamp. While these alternative embodiments require a somewhat larger hole to accommodate entry of the (unexpanded) toggle bolt/molly bolt mechanism, they offer the advantage of a more secure connection as well as permitting the installation of the light fixture by one individual, and without requiring access to the immediate area on the back side of the ceiling. That is, in installing the light fixture, the wire to be used to connect the light fixture can be run through the hole 306 from below the ceiling and then run through (e.g., “snaked through”) the space above the ceiling to a convenient point of mounting and accessing the LED Driver. The wire is then connected to the light source, and the stem of the light source then acts as the toggle bolt/moly bolt screw to attach the light fixture to the ceiling. Thus, in installing these embodiments no access is required to the space directly behind the mounting location. Accordingly, in an advantageous manner, the light fixture of the present invention can be readily mounted at various locations on a vertical wall.

FIG. 7A illustrates an additional embodiment of the invention in which two stems 306 can be employed as the mounting mechanism. FIG. 7B depicts dual spiked stems 702 being employed whereby mounting can occur without requiring the drilling of any holes. The invention also contemplates that mounting can occur with only one spiked stem. In embodiments in which only one spike is employed, the spike could be provided with a tip representative of a twist drill to enable mounting by simply twisting the device. Where such spiked stems are employed, busbars (rather than supply wires in a hollow stem) would be utilized to provide the electrical connections. It should be noted that in embodiments in which two stems are employed, the invention contemplates that one stem can carry both power poles or alternatively, one pole can be carried per stem.

Since there is no recessed housing or plaster frame involved in the present invention, the associated LED Driver 802 can be located at a distance away from the mounting location of the luminaire. FIG. 8A depicts an exemplary NEC Class 2 driver 802 employing a conventional junction box mounted type 804. Also illustrated is a plenum rated flexible cord (806) going to the connector that mates to the mounting stem 306 providing the electrical connection. The junction box 804 is depicted as being secured on a single mounting bracket. In various embodiments of the invention the junction box can be provided with a bracket that would allow clamping directly to the ceiling grid, or nailing/fastening to building structural members. In further embodiments for use with suspended ceilings, a bracket may be provided on the junction box that would enable its attachment to ceiling suspension wires.

As depicted in FIG. 8B, a non-Class 2 LED Driver 808 can be employed in alternative embodiments of the invention. In such embodiments the cable from the driver 808 to the stem 306 needs to be incased in a metal conduit. Any of several metal flexible conduits/cables, as are well-known in the art, can be utilized.

FIG. 8C depicts yet another embodiment in which a mains (branch circuit) junction box 814 can be mounted directly over stem 306. In additional embodiments (not illustrated), junction box 814 can incorporate the stem clamp, and further can contain the LED driver 802.

As noted above, as there is no aperture for the light to pass through, new non-traditional creative light shapes are possible when the current invention is used in luminaire applications. FIGS. 9A-9E illustrate examples of such light shapes as viewed when looking up at a ceiling mounted luminaire.

While the invention has been described above with respect to an LED luminaire, the invention is not so limited as the disclosed mounting means may be used on any ceiling (or wall) mounted device which would typically require a large opening in the mounting surface. Such devices would include luminaires employing alternative light sources (e.g., OLEDs, in-line quad fluorescent tubes, etc.), occupancy/motion detectors, daylight sensors, annunciators, wireless access points, IP/CCTV camera, etc.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A luminaire adapted to be mounted to a surface of a room, the surface having a small hole creating a passageway between an interior side and a back side of the surface, the luminaire comprising:
a printed circuit board containing at least one LED;
a stem, having a proximal end and a distal end, the proximal end being physically connected to the circuit board; the stem in use, providing an electrical connection between a power source and the circuit board;
a retainer attachable to the distal end of the stem such that in use, the stem extends through the small hole, and the retainer attached to the stem on the back side thereby holding the luminaire against the interior side.

2. The luminaire of claim 1 wherein the stem is hollow and whereby it provides a conduit for at least one conductor.

3. The luminaire of claim 1 wherein the retainer is selected from the group consisting of a spring clamp that frictionally attaches to the stem, a toothed ratchet mechanism that engages the stem, and an untoothed ratchet mechanism that engages the stem.

4. The luminaire of claim 2 wherein the stem has a threaded exterior surface and the retainer is selected from the group consisting of a toggle bolt arrangement, a molly bolt arrangement, and a locking nut.

5. The luminaire of claim 1 further comprising a detachable integral trim ring.

6. An electrical device adapted to be mounted to a surface of a room, the surface having a small hole creating a passageway between an interior side and a back side of the surface, the device comprising:
a substrate to which at least one functional electronic components is physically connected;
a stem, having a proximal end and a distal end, the proximal end being physically connected to the substrate; the stem providing an electrical connection to at least one of the functional electronic components;
a retainer attachable to the distal end of the stem such that in use, the stem extends through the small hole and the retainer is attached to the stem on the back side thereby holding the electrical device against the interior side.

7. The electrical device of claim 6 wherein the stem is hollow and whereby it provides a conduit for at least one conductor.

8. The electrical device of claim 6 wherein the electrical device is selected from the group consisting of luminaires, occupancy/motion detectors, daylight sensors, annunciators, wireless access points, IP/CCTV cameras, and combinations thereof.

9. The electrical device of claim 6 wherein the retainer is selected from the group consisting of a spring clamp that frictionally attaches to the stem, a toothed ratchet mechanism that engages the stem, and an untoothed ratchet mechanism that engages the stem.

10. The electrical device of claim 6 wherein the stem has a threaded exterior surface and the retainer is selected from the group consisting of a toggle bolt arrangement, a molly bolt arrangement, and a locking nut.

11. The electrical device of claim 6 in which exactly two stems are utilized, each of said stems having attached to it a retainer on the back side thereby holding the electrical device against the interior side.

12. An electrical device adapted to be mounted to a surface of a room, the surface having an interior side and a back side, the electrical device comprising:
a substrate to which at least one functional electronic components is physically connected;
at least one spiked stem, having a proximal end and a distal end, the proximal end being physically connected to the substrate; the stem providing an electrical connection to at least one of the functional electronic components; wherein in use the spiked stems are inserted through the surface of the room into the back side thereby holding the electrical device against the interior side.

13. A method of attaching an electrical device to a surface of a room, the electrical device comprising an attached stem which provides an electrical connection to the electrical device, the stem having a proximal end and a distal end; the method comprising the steps of;
creating a hole to establish a passageway between an interior side of the surface and a back side of the surface;
inserting the distal end of the stem through the hole; and,
retaining the stem against the back side of the surface thereby securing the electrical device against the interior side.

14. The method of claim 13 further comprising the step of connecting a cable to be used for supplying power to the device to the distal end of the stem after completion of said inserting step.

15. The method of claim 13 further comprising the step of connecting a cable to be used for supplying power to the device to the distal end of the stem before commencement of said inserting step.
